(19) United States
(12) Patent Application Publication
(10) Pub. No.: US 2008/0165967 A1
(43) Pub. Date: Jul. 10, 2008

(54) Method and Device For Migrating a Specifically Encrypted Access Object From a First Terminal Unit to a Second Terminal Unit

(76) Inventors: Andree Ross, Luedinghausen (DE); Dirk Frijters, Bochum (DE); Dirk Gaschler, Wermelskirchen (DE)

Correspondence Address: Hollingsworth & Funk, 8009 34th Avenue South, Suite 125, Minneapolis, MN, 55425, US

(21) Appl. No.: 11/791,201

(22) PCT Filed: Dec. 3, 2004
(86) PCT No.: PCT/IB2004/003974

§ 371 Date: Sep. 26, 2007

(51) Int. Cl. H04L 9/32; H04K 1/00

(52) U.S. Cl. 380/258; 380/270

(57) ABSTRACT

The present invention provides a method, a migration server and a terminal device mor migrating specifically encrypted access objects (such as e.g. a license) between mobile terminals such as e.g. computers and/or cellular telephones. Method for migrating a specifically encrypted access object from a first terminal unit to a second terminal unit is performed according to the invention, by a migration server of a communication network. The method comprises receiving via said communication network, a first specifically encrypted access object of said first terminal unit and identification data related to said first terminal unit and to a content said first specifically encrypted access object is destined for (e.g. an application). Then identification data related to said second terminal unit and a request for issuing a second specifically encrypted access object for said second terminal unit are received at the server via a communication network. The server performs a check if said request is authorized and generates a second specifically encrypted access object for said second terminal unit, being destined for said content, if said request is authorized. The generated second specifically encrypted access object destined to said second terminal unit is then sending via said communication network, to said second terminal.

The present invention relates to the field of digital rights management using online downloads of specifically encrypted access objects (such as e.g. a license) to mobile terminals such as e.g. computers and/or cellular telephones. It also relates to an online licensing system, wherein one or more specifically encrypted access objects (e.g. licenses, rights objects or access objects) are required to execute a content (such as music, video, games, software or text) on a terminal device.

At present it is not possible, however, to sell specifically encrypted access objects (SEAOs) once downloaded to somebody else. Presently the execution and/or acquisition of protected content, for example a game on a terminal device, follows the Open Mobile Alliance Digital Rights Management (OMA DRM) mechanisms. To execute a game, one or several SEAOs must be available in the terminal device. Instead, the developers of SEAOs have only aspired to prevent any possibility to pass on SEAOs to somebody else. The digital rights access mechanisms have only been developed with a main intention to prevent that a user may get access to content without having paid for an SEAO. All efforts have been directed to ensure that a user is prevented from distributing different copies of the content and the SEAOs (e.g. a license) to an indefinite arbitrary number of other devices or friends. These efforts have led to SEAOs allowing the execution/usage of a certain content only on a certain device or only with a certain unit.

These efforts have in turn led to frustrated users not being able to use a SEAOs on e.g. a newly purchased device. Additionally, a re-selling of a purchased SEAO is actually not possible, as the user is not able to decrypt and re-crypt a SEAO, as otherwise there would be no need for any kind of access objects.

During the last years DRM methods became very popular to protect digital content against illegal copying on the basis of new DRM laws that became very popular to protect digital content against previously legal copying.

Before a protected digital content can be used on any kind of device (such as a Personal Computer, mobile phone, Personal Digital Assistant etc.) a valid specifically encrypted access object (SEAO) is required. The term “SEAO” in the following text is intended to cover all elements that are required to make protected digital content usable on a specific device. The expression “SEAO” may be comprised of the items such as licenses, digital rights objects and e.g. public key coded rights objects. That is, the “SEAO” represents any kind of code that is required to execute or use a content such as a program or video, audio, picture or text data.

Presently, the device may receive a SEAO on many different ways. A SEAO can be obtained via any kind of offline secure storage medium (such as e.g. an SD-card or a Secure MMC), a pluggable module (with a hard-coded SEAO) or online via Internet download or communication network download. Due to low costs on the one hand and due to the permanently increasing number of Internet-connected devices on the other hand, the Internet-based and communication network download of SEAOs has become very common for DRM protected digital content.

Hence the secure online download of SEAOs is well specified by popular standards (such as e.g. the OMA DRM standard). In the scope of future gaming platforms common DRM technologies (such as the OMA DRM) are taken into consideration to protect games (and additional game content) against illegal usage. The “storage” of a SEAO on any kind of medium in the following is to be understood so that the SEAO is bound to a specific individual unit such as a device or a storage medium. This case is not to be mixed up with a common backup scenario, in which it is allowed to copy a SEAO to a storage medium but the binding of the SEAO (to a certain unit) remains unchanged. In the following text a SEAO is bound to a certain terminal or a certain storage device. In this framework it is still possible to use a backup copy of a certain SEAO on another storage medium. In case of a storage bound SEAO it is however not possible to execute said backup from the backup medium, with the same storage medium, as the specifically encrypted access object (SEAO) does not fit to the identification of the backup storage medium. In case of a terminal bound SEAO it is possible to execute said backup from the backup storage medium, on the same terminal with the backup storage medium. However, it is not possible to execute any content with the stored SEAO on another terminal, as the SEAO does not fit to the identification of the other terminal.

Presently it is not possible to provide means to “migrate” or “move” a SEAO from a first storage medium to a second storage medium so that it is possible to execute a protected content from the second storage medium, i.e. to adapt the SEAO to the identification of the second storage medium.

However it could be desirable to enable a user to “migrate” or “move” a SEAO from a first storage medium to a second storage medium so that it is possible to execute a protected content from the second storage medium, i.e. to adapt the SEAO to the identification of the second storage medium.

According to a first aspect of the present invention a method is provided to “migrate” or “move” a SEAO from one terminal unit to another terminal unit. In the following text the expression “terminal unit” will be used for “terminal devices” in the sense of a certain entity a license or a SEAO may be coded for. That is, a terminal device such as a e.g. a mobile telephone, a communication enabled computer device such as a communicator or merely a storage medium is intended.

It is intended to execute the method in a migration server directly or indirectly connected to a communication network. The communication network may be WLAN, Bluetooth and other, even wired data connections. The invention can also be implemented for Notebooks, PDAs and PCs. The method of the present invention starts with receiving via said communication network a first SEAO of said first terminal unit and identification data related to said first terminal unit and to a content said first SEAO is destined for. The method further comprises receiving identification data related to said second terminal unit and a request for issuing a second SEAO for said second terminal unit via a communication network.

The method further comprises checking if said received request is authorized, and generating a specifically encrypted access object (SEAO) for said second terminal unit, being destined for said content, if said request is authorized. The method is terminated by sending said generated SEAO destined to said second terminal unit via said communication network.

The present invention provides a new way to migrate the ability to execute or use a certain content from a first terminal unit to another second terminal unit.

The method comprises or starts with a reception of data indicating that a SEAO of a first terminal is requested to be transferred immediately or later to another, second terminal unit. The SEAO is identified by the reception of said first SEAO of said first terminal unit, said identification data related to said first terminal unit and to said identification data related to content said first SEAO is destined for. That is, the present invention relates to SEAOs that are specifically coded according to a certain hardware component (i.e. the terminal unit) and according to a certain content to be executed or used (e.g. a software, audio, video, picture, map, text and/or other “display” data). By transferring said data via a communication network said it is no longer necessary to visit a specific service point of the provider of the device the SEAO is destined for.

It may be noted that both receiving processes, the receiving of a first SEAO of said first terminal unit, its identification and the receiving of identification data related to said second terminal unit may occur at the same time (e.g. in one transmission from a single sending-terminal unit) or with a certain time difference.

It is to be added further that the first SEAO and respective data and said identification data related to said second terminal unit may be received from a single sender terminal unit or may be received each from the respective first and second terminal units.

In a simple embodiment both data may be received from a single (i.e. the second) terminal during a single transmission. This implementation assumes that the data related to the first device have previously been transferred from the first terminal unit to the second terminal unit.

The checking operation if said request is authorized can be embodied in a simple version by a plausibility check. A plausibility check implies only if the data related to the first terminal unit indicate that a certain content could be executed or used on said first terminal. When the result of the check indicates that this is possible it is assumed that the owner of the first device wants to execute or use a specific content on said second device and a specifically encrypted access object (SEAO) for a second terminal unit can be generated.

Here it is also to be noted that the checking operation may comprise additional checking subroutines such as checking a database if said SEAO for the first device has been generated or not. It should be mentioned that a checking operation may be implemented if or that said first SEAO has already been used for requesting a “migrated” SEAO for another device or not, and if so the “migration” may be rejected. It is also envisaged to implement a storing operation in the process to determine the number of secondary SEAO generated on the basis of the first SEAO.

However, the method may be embodied in a more complex manner by implementing additional check up intermediate steps like checking if e.g. a period of validity said first SEAO has been provided with has run off.

If the request for the SEAO is authorized, i.e. has passed all checks, the server generates said requested second SEAO for said second terminal unit, being destined for said content, and transmits said second SEAO to the second terminal unit.

It may be noted that in case that SEAOs are used that are specific for a certain storage element said first and second SEAOs are received from and sent to a same terminal device (wherein only the storage unit in said device is exchanged).

That is, (in contrast to commonly known backups) also the binding of a specifically encrypted access object (SEAO) is changed to the new terminal unit (e.g. storage medium).

In this framework it is also envisaged to code said first SEAOs in the first terminal unit, transfer it to the second terminal unit prior to the transfer of the first SEAO to the migration server. It is contemplated to code this first SEAOs with a public key of said first terminal unit.

However the SEAO can only be used for executing or using a content if and when the first SEAO has been decrypted and encrypted at the migration server for the second terminal unit. This may comprise that in a preceding step the SEAO of the first device has been made unserviceable.

The transfer of a SEAO from a first terminal unit to the second terminal unit may be implemented by the exchange of a pluggable memory device such as MMC storage medium. It is also contemplated to transfer said SEAO from a first terminal unit to the second terminal unit via e-mail, multimedia messages (MMS), via a GPRS connection.

It is also contemplated to transfer an identification of the second terminal unit from the second device to the first device, followed by the migration of the (first) SEAO to the (second) SEAO, followed by the transfer of the second SEAO from the first terminal to the second terminal. This embodiment may have the advantage that a user of the first device may act as a final authorization instance with the ability to interrupt the method directly before the transfer of the second SEAO to the second unit.

In an example embodiment of the present invention said method further comprises generating a voucher data object (VDO), for the generation of a SEAO for another terminal unit for said content, and sending said VDO to said first terminal unit via said communication network. The method of the present embodiment further comprises receiving said VDO from said second terminal unit via said communication network. In this embodiment said checking operation if said request is authorized comprises checking if said received VDO is valid.

It is envisaged to implement a reception of a request for a VDO from the first terminal device.

This embodiment enables a user to separate the actions required from the donor of the first specifically encrypted access object (SEAO) and the acceptor of the SEAO. Is it for example not necessary to pass specific device data from the first terminal unit to the second terminal unit. Additionally the user of the first terminal unit may offer the SEAO without knowing anything about the receiving terminal unit.

SEAOs downloaded from an online server are bound (e.g. due to unique terminal unit encryption key) to the requesting terminal unit. A passing on of SEAOs is possible with the involvement of an online connectivity. The online migration server must be able to upload the (first) SEAOs or at least parts of the SEAO to identify clearly the SEAOs. Once the SEAO are uploaded and identified by the server the SEAO in the mobile terminal unit has to be deleted. The mobile terminal unit will receive the voucher data object (VDO). The VDO can be implemented e.g. by a non-serial unique number. This “serial number” (of the VDO) can be traded to sell the SEAO of e.g. a game. The buyer of the VDO will be able to download the related SEAO.

Once a user of a terminal unit receives said VDO of e.g. a game he has to login to the migration server or the specifically coded access object provider (or an online portal of e.g. games publisher). The terminal unit user has to forward the VDO and can download all SEAOs related to this VDO. Download of SEAOs will be granted after validity check of the e-voucher by the online portal.

In another example embodiment of the invention said receiving of said identification data (related to said second terminal unit) and said request for said second SEAO (for said second terminal unit) and said receiving of said voucher data object are performed substantially simultaneously. In this embodiment said generating of said second SEAO for said second terminal unit, and said sending of said generated second SEAO destined to said second terminal unit are performed substantially successively.

This embodiment puts together the actions required to cash in a voucher data object at a server. The claim illustrates the (at least semi-) simultaneous transmission of said identification data related to said second terminal unit of said request for issuing a second specifically encrypted access object (for said second terminal unit) and said VDO via said communication network. That is, a user connects a server, identifies himself (and/or his device) and sends a VDO for cashing in. In response to receipt thereof the server generates said second SEAO for said second terminal unit, and subsequently sends said generated second SEAO (destined for said second terminal) to said second terminal. That is, the second part of the method can be performed in a short time to enable a quick access for a user to enable quick use of specifically encoded contents. This embodiment may be regarded as a conversion of a VDO to a (second) SEAO.

It is envisaged to use coded or encrypted VDOs. An encrypted VDO may comprise an identification of the first device used to request the VDO. It is also contemplated to use a serial number or a unique characteristic VDO number or signature for identifying each single issued VDO. It may be contemplated to implement data in the VCO comprising information about the issuing instance, the originating first terminal device and the content to be executed (including e.g. an identification and/or a version number of said contents). It is to be noted that the VDO may also be used to provide or distribute updates for certain contents. In case that e.g. a firmware or a downloaded contents turns out to be faulty, defective or outdated the VDO may be used to enable a user to get e.g. “Version 5.3 SEAO” for a voucher obtained by a “Version 5.0 SEAO”.

In a further example embodiment of the present invention said method further comprises storing said VDO in a memory of said migration server. By storing said VDO in a memory of said server a kind of double entry bookkeeping can be implemented in the migration server. This storage operation may be connected with a timestamp and/or flag for “having been cashed in” or “have not been cashed in yet” of said VDO. Thus all data of issued, circulating, and cashed in VDOs are available to the provider of the VDO.

It may be noted that said stored VDO may be deleted with the cashing in of the VDO. It is also envisaged to store the VDO together with said generated second specifically coded access object. This can contribute to prevent that a voucher is copied and sent twice to said migration server.

It may be envisaged to implement a specific VDO database in the server. This implementation may be used to provide a kind of (semi-) anonymous database for countries with restrictive data protection regulations. In contrast to a nearly not achievable database for storing all circulating SEAOs (due to hangover SEAOs), it is possible in the case of VDOs to implement a database comprising data to identify every single issued VDO. This is as if the SEAO/VDO architecture is still to be implemented, and no hangover VDOs are to be considered in the design or the realization of the server or the VDO database. It is envisaged to use a system such as known from the prepaid telephone cards to recharge the account of the telephone to implement a VDO-database. In this case the method of this embodiment would further comprise generating an entry for each generated VDO, and deleting said entry in case said VDO is cashed in.

In another example embodiment of the present invention said migration server is further provided with a database for specifically encrypted access objects (SEAOs). The data base for SEAOs comprises storage entries for (ideally all) circulating SEAOs and (ideally all) terminal units SEAOs have been allocated for. The method of this embodiment further comprises deleting an entry of said first SEAO of said first terminal unit in said data base for SEAOs, and generating a new entry for said second SEAO of second terminal unit in said data base for SEAO.

By using and updating/maintaining the database for SEAOs the provider of the SEAOs can always determine if any request for migrating SEAO is authorized or not. By using said database for SEAOs the provider of the SEAOs can always determine if a certain SEAO has been issued or not. This concept can be used for determining if a possibly executable SEAO has been purchased or has been generated by illegal copying.

The method may be extended by determining that a certain SEAO stored on a terminal unit of a user is not longer valid, and deleting said SEAO.

This embodiment represents a kind of double entry bookkeeping for SEAOs. That is a provider of the SEAOs can always track the actual spreading of issued SEAOs and is capable to determine e.g. an area of distribution of said SEAOs. The provider of the database for SEAOs can access dynamic data about the use and spread of said specifically coded access objects (and hence the spread of a respective execution of content).It should be clear that the database for SEAOs may be a place for storing said VDOs in.

In just another example embodiment of the method of the present said method is extended by an operation for checking, if there is an entry of said first specifically encrypted access object (SEAO) of said first terminal unit in said data base for SEAOs. In case of a negative checking result a migration refusal message may be generated, that can be sent sending to said first terminal device and said the method can be terminated before a said entry is generated and/or before said second SEAO is generated.

By implementing the checking operation it is ensured that a desired migration is actually determined, if there are any recordings of previously performed allocation of a first SEAO to the first device. It may be implemented that in case that no entry of a first SEAO is present in the data base (e.g. due to a hangover of “old SEAOs” from the time before the database has been established) then a presence of such an entry maybe assumed (resulting in a positive checking result), and a “negative entry” may be generated. Thereby, it can be prevented that a single device with a number of pre-database SEAOs can use the database for providing an unlimited number of “officially” migrated SEAOs.

In case that there is such an entry, the method an be proceeded in a conventional manner. In case that there is no such an entry it is expected that the first SEAO has not been obtained by the first device in an intended manner. In case that there is no such an entry, it may also be expected that it has not been intended that the first SEAO has been obtained by the first device. Thus, the method may be extended by the step (of the following embodiment) of dispatching a command to the first terminal unit to delete said first specifically encrypted access object (SEAO). That is, if a terminal connects the migration center to migrate a first SEAO, and there are actually no entries in the database for specifically encrypted access objects (SEAOs) the migration server may construe that the first SEAO that must have been accidentally provided to the first terminal device. In this case the migration server may delete the first SEAO from the memory of the first terminal.

By generating and sending a “migration refusal message”, in case of a negative checking result a user that tried to migrate a SEAO can be informed that in the migration server's opinion a migration is to be rejected. With the transmission of the migration refusal message, the migration can be terminated of interrupted, before said new entry and/or said second SEAO are generated.

According to yet another example embodiment said method further comprises dispatching a command to the first terminal unit to delete said first specifically encrypted access object (SEAO), via said communication network. Thereby it may be assured that the first specifically coded access object is deleted on the first device (e.g. following or before the deliverance of a VDO or the second specifically coded access object).

In still a further example embodiment of the present invention said method further comprises the reception of a confirmation from said first terminal unit, confirming that said first SEAO has been deleted.

According to just another aspect of the present invention a method for forwarding a voucher data object (VDO) via a terminal device is provided. The method comprises receiving a VDO at said terminal device via a communication network, storing said VDO in a VDO storage said terminal device and sending said VDO from said terminal device via said communication network.

Deleting said VDO from said VDO storage may extend the method. Thereby, it can be assured that a user can not multiply a VDO for accessing an arbitrary number of secondary SEAOs. In the claims it has been left open whether the terminal receives said VDO from a migration server or from another device. Similarly, it has been left open in the claims, whether the terminal sends said VDO to a migration server or to another device. Anyhow, it is intended that the VDO is transferred from the migration server to a first device, from the first device to a second device and back to the migration server. It does actually not matter if the VDO is returned directly from the first device to the migration server as this is also possible, if e.g. a user can not find someone to “pass” the SEAO. It may also happen that the VDO is transmitted to a third, fourth, fifth device before being transmitted to the second device for redeeming said VDO at the migration server for a secondary SEAO. It may be noted that the VDO is provided for obtaining/migrating a SEAO. It may also be noted that the transfer of the VDO may be accompanied by transmissions of first specifically encrypted access objects (SEAOs) of the first terminal unit. It is also envisaged to transfer identification data related to said first terminal unit and to a content said first SEAO is destined for. It is also contemplated to transfer additionally identification data related to said second terminal unit and a requests for issuing a second SEAO for said second terminal unit, and requests for issuing second SEAOs. Precautions could be taken that any backup of a VDO is impossible. It may also be envisaged to implement means for assuring that the VDO is reliably deleted from the storage of the sending device in any case said VDO is sent.

In still another example embodiment of the present invention said communication network is a cellular communication network and said terminal device is a mobile cellular terminal of said cellular communication network. That is the present invention may be related to a system for providing computer programs for terminal devices such as e.g. mobile phones or mobile phone enabled communicators. The present invention can also be used for delivering SEAO to e.g. video game enabled cellular telephones. It is to be emphasized that the communication network of both methods, the method for migrating SEAOs and the method for forwarding VDOs can be executed in a cellular (mobile) (telephone) communication network.

According to yet another aspect of the invention, a software tool is provided comprising program code means for carrying out the method of the preceding description when said program product is run on a computer or a network device.

According to another aspect of the present invention, a computer program product downloadable from a server for carrying out the method of the preceding description is provided, which comprises program code means for performing all of the steps of the preceding methods when said program is run on a computer or a network device.

According to yet another aspect of the invention, a computer program product is provided comprising program code means stored on a computer readable medium for carrying out the methods of the preceding description, when said program product is run on a computer or a network device.

According to another aspect of the present invention a computer data signal is provided. The computer data signal is embodied in a carrier wave and represents a program that makes the computer perform the steps of the method contained in the preceding description, when said computer program is run on a computer, or a network device.

According to just another aspect of the present invention a migration server of a communication network for migrating a specifically encrypted access object (SEAO) from a first terminal unit to a second terminal unit is provided. The migration server comprises an interface to said communication network, a checking means, generating means for generating second SEAOs and at least one storage.

Said interface to said communication network is provided for communicating with terminal devices. The migration server can receive e.g. a first SEAO of said first terminal unit and identification data related to said first terminal unit and to a content said first SEAO is destined for via said communication network interface. The migration server can further receive identification data related to a second terminal unit and a request for issuing a second SEAO for said second terminal unit. Said interface is also capable of sending generated second SEAO destined to said second terminal unit via said communication network.

The checking means is provided for checking if received requests are authorized. The checking means is further connected to said interface (for obtaining said requests for the checking operation). The checking means is configured to determine if a received request for a second specifically encoded access object is authorized or not.

The migration server is provided with a generation means for generating second SEAOs. This generating means connected to said checking means, for generating a second SEAO for said second terminal unit, being destined for said content (said first SEAO has also been destined for). Said generating means is configured to generate said second specifically coded access object according to a received identification data related to said second terminal unit, if said request is authorized (or a signal from the checking means is received indicating that the request is authorized).

The at least one storage configured for storing SEAOs is provided in the migration server and is connected to said authentication means.

In an example embodiment said migration is further provided with a means for generating a voucher data objects. In this embodiment said interface to said communication network is also configured to send and receive voucher data objects via said communication network. In this embodiment said checking means is configured to check also if a received voucher data object is valid.

The use of VDOs implies that a user may request a VDO for a SEAO and may subsequently exchange this VDO for the same SEAO said VDO has been obtained for. This aspect is important, as the VDOs have been introduces to enable a migration of a SEAOs. If during a migration process the reason for this migration vanishes, a user should have a chance to migrate the SEAO back to the first device. In this special case the first SEAO and the second SEAO are identical. In a slightly modified procedure this back exchange may be used to provide updates for special SEAOs to users.

In another example embodiment said migration server further comprises a database for SEAOs. The database comprises storage entries for (ideally all) circulating SEAOs and (ideally all) terminal units SEAOs have been allocated for. Said data base for SEAOs is connected to said a checking means and to said generating means.

The data base for specifically encrypted access objects represents a kind of “log file” or “family album” of the circulating SEAOs. The migration server maintains and adapts the SEAO database by deleting entries of said “leaving” first SEAOs of said first terminal units in said data base for SEAOSs, and generating new entries for said “being moving there” second SEAOs of second terminal units in said data base for SEAOs. That is, the migration server acts as a kind of “registration office” for SEAOs to ensure that SEAOs do not “reproduce” during a number of migration procedures.

In still another example embodiment of the present invention said communication network is a cellular communication network. That is, network server is a server of a cellular communication network, said interface is an interface to said cellular communication network configured for receiving at least one terminal device identification of a mobile cellular terminal device. That is, the present invention may be related to a server configured for providing SEAOs for computer programs for mobile cellular terminal devices such as e.g. mobile phones or mobile phone enabled communicators. The present invention can also be used to deliver SEAO to video game enabled cellular telephones.

According to just another aspect of the present invention a mobile terminal device is provided that is capable of forwarding voucher data objects (VDOs). The terminal device comprises a communication network interface, a central processing unit and a VDO storage. Said central processing unit is connected to both said communication network interface and said VDO storage.

The mobile terminal device of the present invention is provided with the capability to receive and send, i.e. to forward a voucher data object (VDO) via a communication network. In contrast to the number coded typed in prepaid mobile phones the voucher data object is also received via said communication network. It is also to be noted that the VDOs are issued and destined for migration servers and are provided for migrating SEAOs. That is, the terminal device is also capable of sending or receiving SEAOs, terminal unit and identification data, and requests for issuing a second SEAOSs, or VDOs. In the claims it has been left open whether the terminal is capable of receiving and sending VDOs to/from a migration server or to/from another terminal device. Precautions may be taken that any backup of a VDO is impossible. It may also be envisaged to implement means for assuring that the VDO is reliably deleted from the storage of the sending device in any case said VDO is sent.

It is further contemplated to provide the terminal device with a user input interface (such as a e.g. a keyboard of a joystick) and with a user output interface (such as a display or a touch screen).

In an example embodiment of the present invention said mobile terminal device is a mobile cellular terminal device for a cellular communication network, such as a mobile telephone or a communicator. In this case said communication network interface is an interface to said cellular communication network such as e.g. a GSM or UMTS radio module.

In the following, the invention will be described in detail by referring to the enclosed drawings in which:

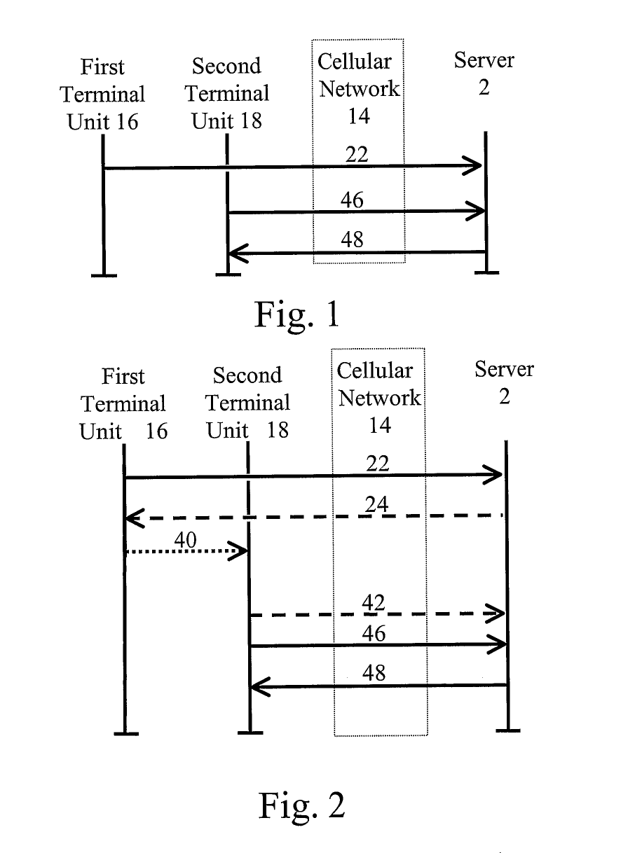

FIG. 1 is a flowchart of a basic embodiment of the present invention for migrating a specifically encrypted access object (SEAO) from a first terminal unit to a second terminal unit,

FIG. 2 represent a flowchart of a basic embodiment using a voucher data object (VDO) to migrate a SEAO from a first terminal unit to a second terminal unit, using VDOs,

FIG. 3 visualizes the requirements for migrating a conventional SEAO between different media,

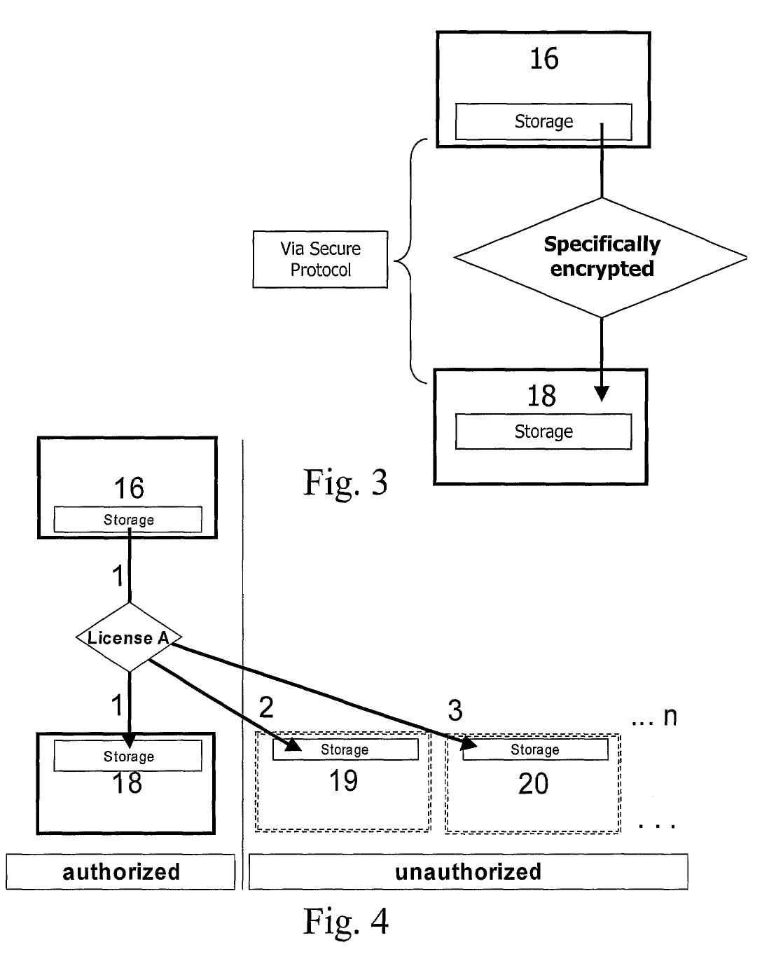

FIG. 4 visualizes the “snow ball” effect,

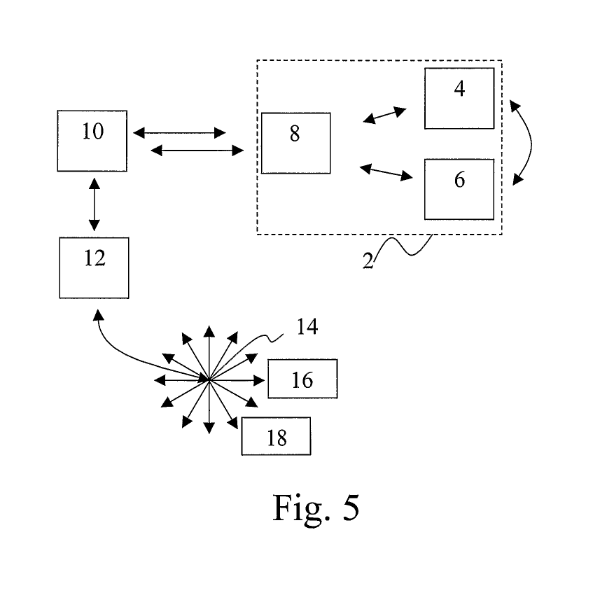

FIG. 5 depicts a possible implementation of a system for migrating SEAOs,

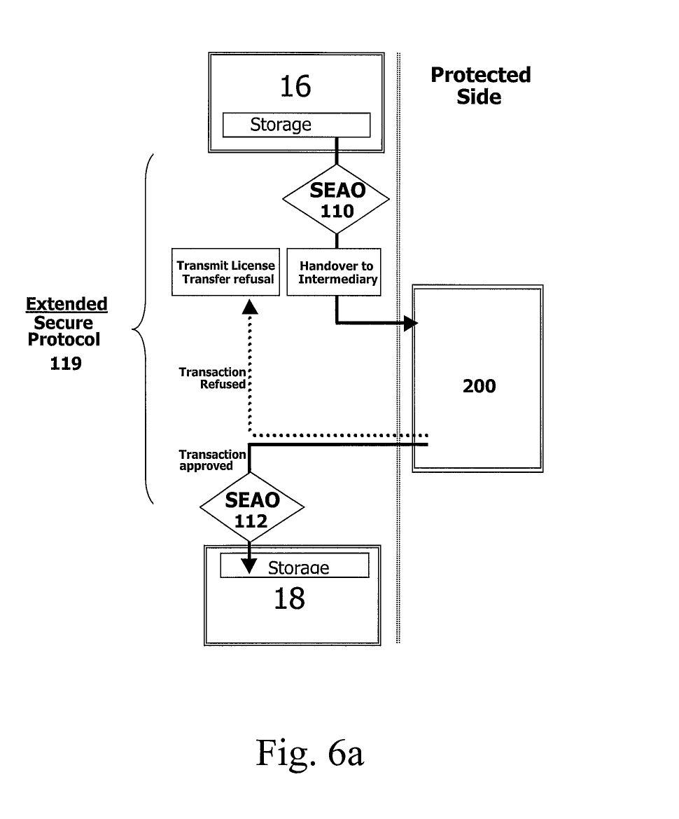

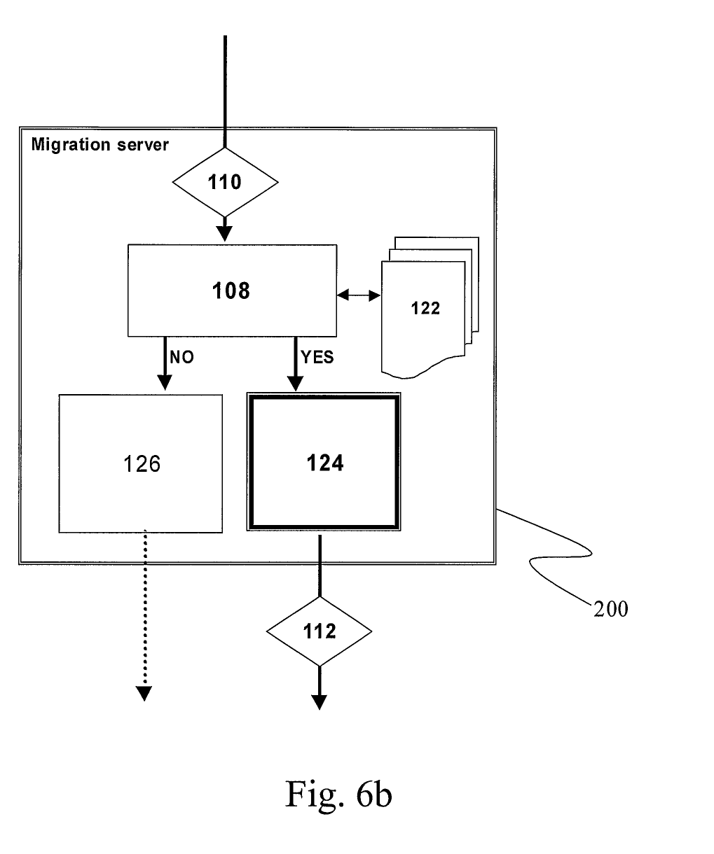

FIG. 6a and 6b depict a specifically coded access object migration managed by trusted online migration server,

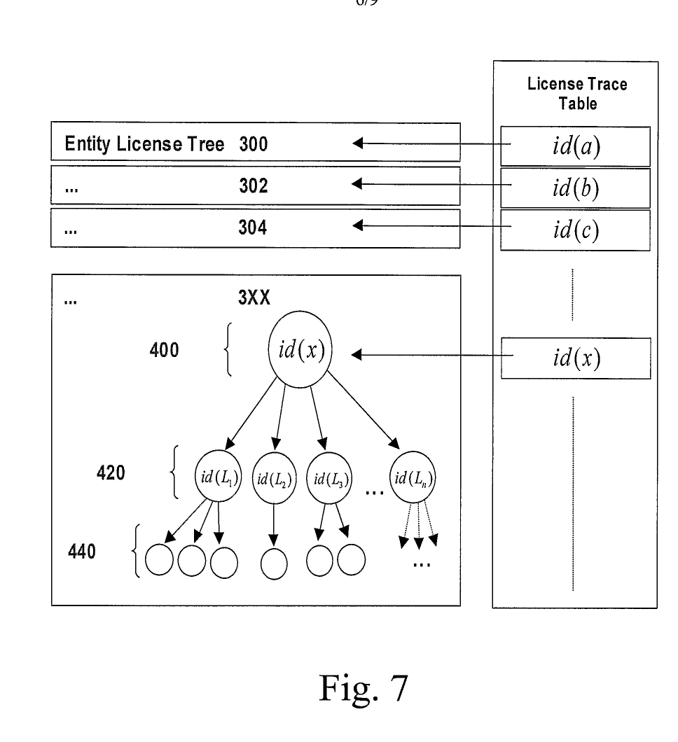

FIG. 7 visualizes a look-up table containing information about what specifically coded access object is stored on which terminal unit,

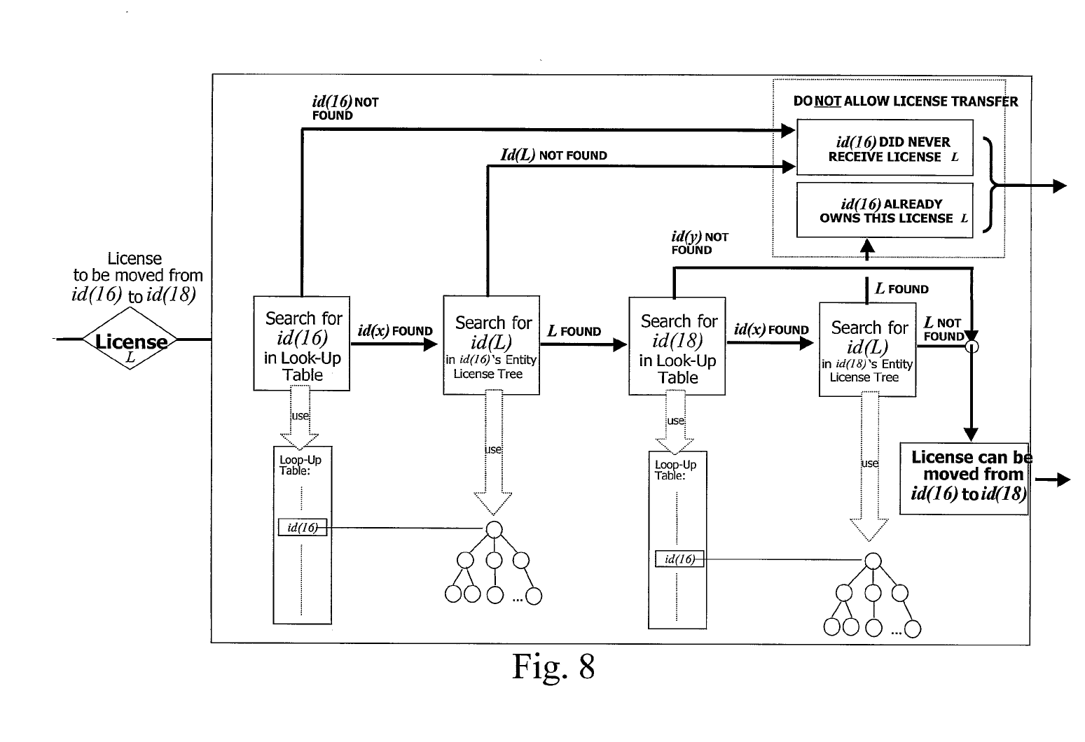

FIG. 8 depicts how a check if transmission is allowed can be implemented,

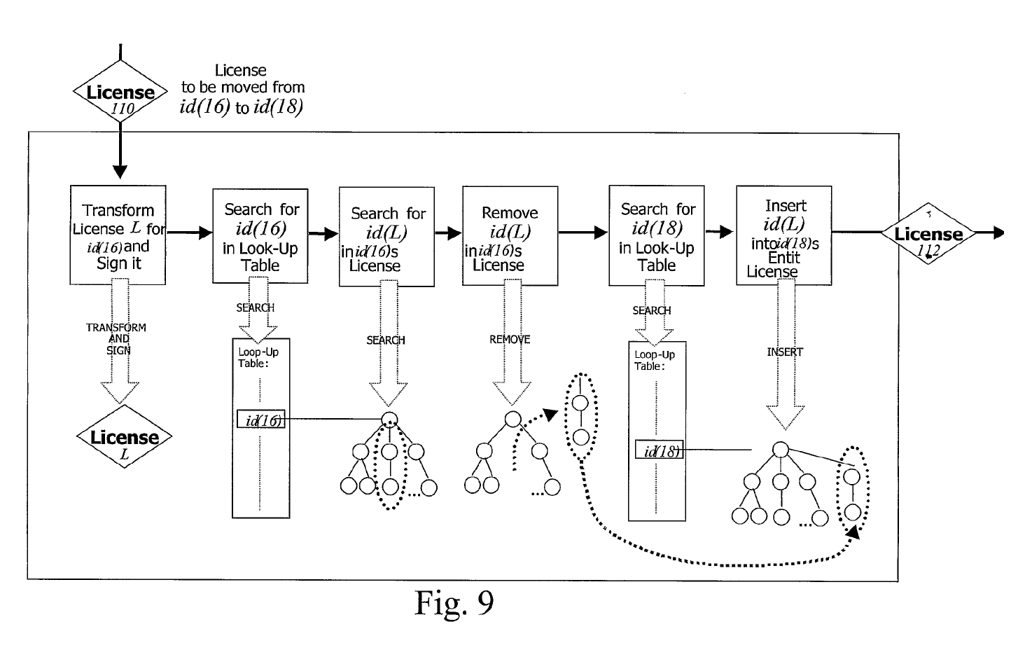

FIG. 9 visualizes a migration of a license by the use of look-up tables and SEAOs transformation, and

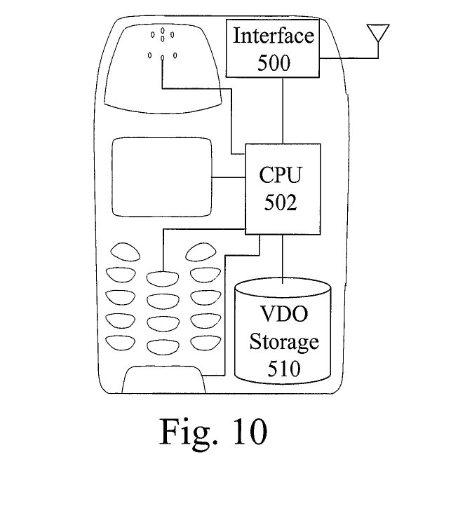

FIG. 10 depicts a mobile terminal device configured for receiving and forwarding VDOs.

In the detailed description that follows, same or identical components have been given the same reference numerals, regardless of whether they are shown in different embodiments of the present invention. In order to clearly and concisely illustrate the present invention the drawings may not necessarily be to scale and certain features may be shown in somewhat schematic form.

FIG. 1 depicts a flowchart of a basic embodiment of the present invention for migrating a specifically encrypted access object (SEAO) from a first terminal unit to a second terminal unit. The initial steps how the first terminal has acquired the first SEAO have been economized. It is expected that e.g. a user of the first terminal unit 16 wants to execute a certain content on a second terminal unit 18 he obtained. Due to the specificity of the specifically coded access object it is not possible to transfer the first SEAO directly to the second terminal unit, e.g. because the devices have different private keys for decoding said SEAOs. The SEAOs can be delivered via a communication network such as e.g. a cellular communication network. In the figures the terminal device is embodied as a mobile cellular terminal device and said a communication network is embodied as a cellular communication network without any limitation of the claims.

In the present scenario the user transfers the specifically coded access object from the first terminal unit to the migration server 2 via said cellular communication network 14. The user may also transfer e.g. the international mobile device identification (IMEI) of the first device to the migration server.

In a next step the second terminal unit 18 transfers 46 the device identification of the second terminal unit 18 together with a request for the migration of said first SEAO of the first terminal unit 16 to a second SEAO of the second terminal unit 18 to the migration server 2.

The migration server decrypts the received first SEAO according to the data of the first terminal unit 16 to an unencrypted access object. The migration server encrypts the unencrypted access object according to the data of the second terminal unit 18 to a second SEAO.

Finally the migration server 2 sends the generated second SEAO to the second terminal unit 16 via said cellular network 14.

FIG. 2 represent a flowchart of a basic embodiment using a voucher data object (VDO) to migrate a SEAO from a first terminal unit to a second terminal unit. The steps of FIG. 2 are comprised of the steps as the steps of FIG. 1. In contrast to the method of FIG. 1 the migration server generates a VDO for the first terminal unit 16. The generated VDO is then transmitted 24 via said network 14 to the first terminal unit 16.

The VDO received at the first terminal unit 16 can be passed on 40 to a second terminal unit 18, directly or in turn via said network 14.

The second terminal then sends said received VDO via said network 14 to the migration server 2. The voucher data can be used to authorize the second terminal unit 18 to request the generation and the transmission 48 of a second specifically coded access object.

In FIG. 3 a terminal unit 16, which has received the SEAO via Internet download to an offline distribution storage medium (such as e.g. a secure MMC or an SD-card, or from one SD-card to another SD-card). If the resale of SEAOs or the migration of SEAOs among different storage media is provided, this may open doors for hackers for bypassing the protected paths of SEAOs, as the SEAOs cover all features (in any digital format) to make any (specific) protected digital content usable. Conventionally the SEAO is uniquely bound to a single terminal unit 16, 18 such as a mobile phone, a gaming console, a personal computer, a personal digital assistant, a communicator or an online Server.

It is also envisaged to bind a SEAO to a certain storage medium such as an SD (Secure Digital) card or a (secure) multimedia card (MMC) serving as a terminal unit.

The transfer always requires a secure protocol to cover all secure operations that are required to migrate (i.e. move and not copy) a SEAO in a secure way from the storage of terminal unit 16 to the storage of terminal unit 18. This may require tamper-resistant hardware operations that may be included while executing a secure protocol. During transfer the SEAO needs to be released from terminal unit 16 and it also needs to be bound to terminal unit 18.

It is clear that the transfer of the device would be simplest transferred in an unencrypted way, but this would enable arbitrary unauthorized copying. That is, if a migration process is planned in a specifically encrypted access object (SEAO) environment precautions may be taken to prevent the “snowball-effect” (see FIG. 4).

FIG. 4 depicts a diagram showing the snowball effect that can occur when one SEAO can unauthorized be multiplied to many SEAOs, which may be made available for unauthorized downloads. That is, a single unauthorized copy of an unencrypted access object may spread fast undermining any efforts to prevent unauthorized copying. If e.g. the same SEAO 110 is moved to several devices 18, 19, 20 . . . or respective storage media, so that it can be used on devices or storage media independent from terminal unit 16, there is no need for anyone to purchase a SEAO.

FIG. 5 depicts a possible implementation of a system for migrating specifically encrypted access objects (SEAOs). The system of the depicted embodiment comprises a cellular communication network 14, wherein two different terminal units 16, 18 are connected to said cellular communication network 14. The online portal 12, e.g. a company server, is connected to said cellular communication network 14 for providing public relations and representation. The online portal can also be used for providing content, online interaction between terminal units 16, 18 and the like. An access to the online portal can be granted with username, password and e.g. International Mobile Equipment Identification (IMEI).

The online portal can be provided with a content server 10 (for content such as game titles and game features). The server can maintain all available online features. The online feature of interest is here the “Reselling of SEAOs”.

The online portal 12 or at least the content server 10 is to be capable of performing terminal unit authentication. A specific authentication server 8 can perform this authentication. The authentication can be based on a mutual authentication based on a Public/Private key infrastructure. The terminal unit and the authentication server 8 can be provided each with a unique private/public key pair.

The authentication server is connected to a migration server 2 comprising a SEAO server or entity 4. The SEAO server 4 that checks the validity of the uploaded specifically encrypted access object (SEAO) or the validity of parts of the uploaded SEAO.

The migration server 2 further comprises a voucher data object (VDO) server or entity 6. The VDO server can on demand generate a VDO. The request can be received or can be validated from SEAO server 4 just after the validation of a received SEAO. It is also envisaged to implement a connection from the VDO server 6 to the authentication server 8.

System, i.e. all components, but especially the terminal units 16, 18, the SEAO server 4, and the VDO server 6 can support a SEAO acquisition protocol (such as ROAP).

In the system the terminal units 16, 18 require a key pair of a private/public key pair for authentication and asymmetric encryption/decryption of the SEAOs. The terminal units 16, 18 should also be capable of permanently deleting “voucherized” SEAOs.

As already indicated in FIG. 2 the method for migrating SEAOs can be implemented according to the following procedure.

User connects with his terminal unit to the online portal 12 with e.g. username, password and IMEI

The user selects “Migrating of SEAOs” in the selection menu of the online portal 12.

After mutual authentication the user has to select the SEAOs to be migrated sold out of his domain.

The SEAOs or part of the SEAOs will be transmitted (e.g. via a ROAP) from the terminal unit 16 to the SEAO server 4 at the online portal.

The SEAO server 4 checks the validity of the received SEAOs

In case the SEAO server 4 authorizes the VDO server 6 to create a valid VDO (wherein said voucher being assigned to a certain content e.g. a game title/game feature, video, audio or text data) of the received SEAOs. The created VDO is represented by a digital code, and may therefore be called an e-voucher.

The e-voucher will be transmitted to the first terminal unit and seamlessly the specifically encrypted access object (SEAO) or entry inside the first terminal unit 16 will be deleted.

The user can now store, forward or sell the e-voucher to anybody or use the e-voucher to migrate a certain SEAO to another terminal device.

FIG. 3 visualizes the requirements for migrating a conventional SEAO.

At present there are DRM standard for mobile devices and terminal units precisely defining how online acquisitions for SEAO can be implemented (if a terminal unit 16, 18 requests a SEAO from a SEAO server e.g. via a cellular communication network). However, there are no secure processes for SEAO resale or SEAO migration. FIG. 3 visualizes the necessity for a user to migrate a SEAO from a first terminal unit 16 to another terminal unit 18.

FIGS. 6a and 6b depict a specifically coded access object migration managed by trusted online migration server. FIG. 6a shows a possible implementation of the general large area architecture, wherein an online migration server 200 is involved in every transmission of a SEAO 110,112. The migration server 200 contains a dedicated check instance 108, which is capable of detecting non-authorized SEAO transmissions to prevent possible snowball effects. It is also envisaged to allow only the transmissions of SEAO to another terminal unit, and that for example the transmission from a terminal device to any storage card may not be executed. The migration server 200 is located on the online side and performs all operations that are required to release a SEAO from a terminal unit 16. The migration server 200 also performs the required operations that are necessary to bind the released SEAO to a new terminal unit 18. For that purpose the trusted online migration server 200 is involved into the secure SEAO transmission protocol. Every time if a SEAO transmission is to be performed in any direction the migration server needs to be contacted via a secure protocol. At a certain point within the secure protocol the (transfer request for a SEAO) the terminal unit 16 hands over to the migration server 200 and provides the migration server 200 with necessary data such as unique SEAO identification, unique terminal unit (i.e. medium or device) identification of both involved terminal units 16, 18. After handover to the migration server it will be checked if the specifically encrypted access object (SEAO) transfer is allowed.

FIG. 6b is a detailed diagrammatic view of a migration server 200. The migration server 200 contains a dedicated check instance 108. The checking instance 108 can access a number of apply rules 122 for authorized SEAO transmissions. The apply rules can be implemented in a simplest manner by a plausibility check, determining if a certain first SEAO 110 is received from a terminal unit 16 that is capable of executing a certain content. That is, in a simple case it is only checked if it is probable that the received license 110 is received from a probably authorized owner. I more sophisticated apply rules 122 it may be envisaged to check if a certain first SEAO 110 has previously been sent from the terminal unit 16. This may indicate that the first SEAO 110 has been back-upped and has been provided for retransmission to achieve two transferred SEAO. The second transmission may also indicate that a user has repurchased the first SEAO 110 for a second time and wants to pass the repurchased first SEAO 110 to another terminal unit.

It is clearly visible that there are many different applicable apply rules 122 that may be implemented for the dedicated check instance 108, to decide if a requested transfer of a first SEAO 110 to another terminal unit 18 is authorized or not.

If the checking instance 108 determines that a requested transfer of a SEAO 110 is not authorized the transfer of the SEAO 110 to the terminal unit 18 is refused and the sending terminal unit 16 is notified about this refusal. The generation of the notification that the requested transfer is not authorized can be implemented in a dedicated refusal instance 124.

If the checking instance 108 determines that a requested transfer of a SEAO 110 is authorized a SEAO 112 encrypted according to the data of the terminal unit 18 is generated. The generated SEAO 112 is then transmitted to the terminal unit 18, and the first terminal unit 16 is notified about this transmission. It is also contemplated to implement a deletion of the first SEAO in terminal unit 16. This may be possible if the migration server has an online access to the terminal unit 16 and is provided with the authority to delete the first SEAO 110 in the storage of the first terminal unit 16. The generation (and signing if required) of the specifically encrypted access object (SEAO) 112 can be implemented in a dedicated preparing and signing instance 124. The transmissions of the SEAOs 110 and 112 can be performed via an extended secure protocol.

FIG. 7 visualizes a look-up table containing information about what specifically coded access object is stored on which terminal unit. FIG. 7 shows a table with the information about which SEAO is stored on which medium (or terminal unit), which can be managed very time-efficient.

The table may comprise an entry (or a “sub-table”) 300, 302, 304, . . . 3XX for each terminal unit. The look-up table contains an entry for every terminal unit that stores a SEAO, it may also be envisaged to implement an entry for each terminal unit that can store a SEAO or once has stored a SEAO. That is, each terminal is registered with a unique terminal unit identification id(x) 400 identifying a terminal device (x) or a storage medium (x).

Each terminal unit identification id(x) 400 is allocated a number (including zero) of SEAO identifications id(L₁), id(L₂), . . . id(Lₙ) 420 stored on the terminal unit 3XX. Id(Lₙ) is a SEAO identifier for a SEAO that might be composed of more elementary SEAOs information components. The SEAO identifications can be implemented as a SEAO tree. This SEAO tree can contain the information of which SEAO has been installed on each of the entities being involved in a transfer of a SEAO. It is also envisaged to implement a kind of history table to access information about the utilization chain of each SEAO. This information would enable to predict a certain course of spreading of a certain content or of certain SEAOs. This would also enable an adaptation of selling conditions for new SEAOs.

Each of the SEAO identifications id(L₁), id(L₂), . . . id(Lₙ) 420 is allocated with a number of elementary access object 440.

The use of this table allows to trace the transfer of all SEAOs.

FIG. 8 depicts an implementation of check for determining if transmission is allowed or not. The description of “authorized transactions” can be given as set of rules that define an authorized migration and/or as a set of rules defining unauthorized migrations. FIG. 8 depicts a simple example implementation. Every transmission of a specifically encrypted access object (SEAO) can anonymously be logged, and the migration server 200 (or the checking instance 108) has always the knowledge about the state (and the storage) of all circulating SEAOs. This enables an easy detection of unauthorized attempts to migrate a SEAO. The information about which SEAOs are stored on which terminal unit can be stored in a database table (as depicted in FIG. 7). The database table can be managed very time-efficient. If the migration of a first SEAO 110 from terminal unit 16 to terminal unit 18 is allowed, the migration server 200 prepares the second SEAO 112 for the receiving terminal unit 18. As defined in the preceding text a terminal unit can be everything that is capable of storing SEAOs. Finally the SEAO 112 is signed. With the signing process it is prevented that anybody (or any device) else beside the migration server 200 is capable of performing those generation of said second SEAOs 112. If the transfer of a first SEAO 110 is allowed and the second SEAO 112 has been prepared for usage on the destination terminal unit 18, the migration server 200 hands over back to the second terminal unit 18 and sends the prepared second SEAO 112 to the requesting terminal unit 18. Finally the second terminal unit 18 continues performing the secure protocol with the second SEAO 112.

FIG. 9 visualizes a migration of a license by the use of look-up tables and SEAOs transformation. The idea behind the apply rules 122 in the checking instance 108 can be implemented in a very simple way by just following the principle that a terminal unit entity can only transfer or migrate those SEAOs that this terminal unit has received before. It is estimated that migration cannot be authorized if a terminal unit shall transfer a SEAO it never has received before.

It may also not desirable that an entity shall receive a SEAO (with a unique serial number etc.) a second (third or more) time. In these mentioned (very simple) cases, the migration server may not perform the transfer of the SEAO. Thus any duplication of SEAOs can be prevented. Depending on the selected apply rules 122 for authorized migrations of SEAOs the checking procedure may become much more complex.

According to the invention a transfer from a first terminal unit 16 to another second terminal unit 18 always requires the involvement of the migration server 200 as a trusted intermediary. If specifically encrypted access objects (SEAOs) between two entities (without any online connection) shall be exchanged an authorized device has to work as connection intermediary (which is not to be mixed up with the trusted intermediary on the online side!).

It is envisaged to use a public/private key infrastructure to encode the SEAOs, wherein the migration server and other authorized entities require an access to these keys.

In summary the migration server is a protected online server, which operates on a kind of SEAOs database and performing a kind of double entry bookkeeping for all circulating SEAOs. The migration server is contacted (using a secure protocol) if a migration of a SEAOs is requested by a terminal unit. The migration server 200 is provided with necessarily unique identification data 300-3XX of all involved entities and the uniquely identification data of the SEAOs 420. As unique identification data the may be implemented as e.g. certificates of the two terminal units involved in the migration of the SEAO. Using private/public key infrastructures may enable this. The SEAO should also have a kind of unique identification, maybe a kind of serial number. All in the entities (terminal unit and servers) embedded in the environment and the circulating SEAOs are managed within a surveillance or tracking table (see. FIG. 7). Due to the great number of entities and the great number of SEAOs the tracking table the data content may be very extensive.

It is contemplated that an entry in this table is allocated to each terminal unit if it (at all) receives a SEAO for the first time. This entry contains the root of the terminal unit SEAOs tree, which contains all SEAOs identifiers. The check if a terminal unit has a SEAOs is performed within this SEAOs tree. If an entity owns a SEAOs the SEAOs identifier id(L) is found in this tree. The search can be implemented in a very time-efficient manner. Also the operations to release a SEAOs from a terminal unit can be implemented very time-efficient.

These operations are operations as commonly implemented for tree data structures. If a specifically encrypted access objects (SEAOs) is to be released from an entity 16, the corresponding sub-tree (that finally contains all information related to this SEAOs) is taken out of the SEAOs tree for terminal unit 16. The owner of this SEAOs simply changes if this taken sub-tree is embedded into the SEAOs tree of the new SEAOs owner 18.

FIG. 10 depicts a mobile terminal device configured for receiving and forwarding voucher data objects (VDOs). The mobile terminal is provided as a conventional mobile terminal with an interface 500 to a radio communication network via an antenna. The terminal device is embodied as a conventional mobile cellular terminal with a central processing unit (CPU) 502. The CPU 502 is connected to microphone, a keyboard, a display and a loudspeaker to provide conventional mobile terminal functionality. The terminal device is also provided with a dedicated voucher data object (VDO) storage 510 to store VDOs that have been received from a voucher server as depicted e.g. in FIG. 2 or 5. A user can use the device to pass on a VDO to another terminal device via said interface 500. It is also envisaged that a user may use e.g. another interface such as a short-range radio or an Infrared interface (not depicted) to receive or send a VDO from or to another terminal device. When user wants to cash-in a stored VDO, the VDO is transferred from the VDO storage 510 via CPU 502 and the interface 500 to a migration server (not depicted) together with identification data of the terminal device.

The invention may be used (partly) for mobile products, especially for offline distribution media and resell of SEAOs. The invention can be interpreted as an extension to an applied digital rights management standard (as e.g. the OMA DRM standard), which until today only supports online operations of SEAOs and excludes offline SEAOs operations.

It is very difficult to circumvent the migration server 200 as trusted intermediary, because it is an online server, which can only be requested by authorized terminal units, and several protection techniques can be implemented to protect the online migration server 200 against e.g, hacker attacks.

It is not easy to fake an SEAO, because they are signed and modified (in order to change the terminal unit) only on the protected trusted online migration server side. That is, there are no offline operations performed, which may be imitated or hacked to enable the undesired unauthorized copying and/or migrating.

However, it is to be noted that the present invention is claimed with a SEAO. The expression “comprising” has been selected in the claims to encompass the migration of more than one single SEAO also. For the sake of conciseness and clarity the laborious phrases “ . . . at least one . . . ” and “ . . . at least one of said at least one . . . ” have been avoided in the claims.

With the invention the user of a SEAO (e.g. a SEAO of a video game) will be able to pass on, give away or sell SEAOs (and thus also video games). The SEAOs can be traded (e.g. in an online auction) as commercial goods.

The present invention allows the control and the surveillance of circulating SEAOs from several perspectives. The spreading of unauthorized copies of specifically encrypted access object (SEAO) and especially the “snow ball effect” can be prevented. With the present invention is possible to detect unauthorized copies of SEAOs.

The present invention allows for fast reactions in case of detected unauthorized SEAOs, (by at least refusing unauthorized transfers SEAOs)

The method of the present invention is difficult to circumvent, because the migration server (e.g. as a protected online server) can be protected well by firewalls and high level access restrictions.

SEAOs cannot be faked, because only the migration server on the protected online side will perform the change of the allocation of the SEAOs to a certain terminal device.

The methods and devices of the present invention allow for the first time offline distribution media (such as secure memory cards) being part of a closed DRM-based SEAOs distribution system.

Even if it should be possible to copy a SEAO from one secure memory card to another, the copied SEAOs would not work for the new card, because the trusted intermediary is the only instance that is capable of preparing the SEAOs for new media (->by giving mandatory digital signatures).

This application contains the description of implementations and embodiments of the present invention with the help of examples. A person skilled in the art will appreciate that the present invention is not restricted to details of the embodiments presented above and that the invention can also be implemented in another form without deviating from the characteristics of the invention. The embodiments presented above should be considered illustrative, but not restricting. Thus the possibilities of implementing and using the invention are only restricted by the enclosed claims. Consequently various options of implementing the invention as determined by the claims, including equivalent implementations, also belong to the scope of the invention.

1. Method comprising:
receiving, via said communication network, a first specifically encrypted access object of said first terminal unit, and identification data related to said first terminal unit and to a content said first specifically encrypted access object is destined for;
receiving, via a communication network, identification data related to said second terminal unit, and a request for issuing a second specifically encrypted access object for said second terminal unit;
checking if said request is authorized;
generating, if said request is authorized, a second specifically encrypted access object for said second terminal unit, being destined for said content; and
sending, via said communication network, said generated second specifically encrypted access object destined to said second terminal unit.

2. Method according to claim 1, further comprising:
generating a voucher data object, for the generation of a specifically encrypted access object for another terminal unit for said content;
sending said voucher data object, to said first terminal unit via said communication network;
receiving said voucher data object, from said second terminal unit via said communication network;
wherein said checking operation if said request is authorized comprises checking if said received voucher data object is valid.

3. Method according to claim 2, wherein
said receiving of said identification data related to said second terminal unit and of said request for issuing a second specifically encrypted access object for said second terminal unit via a communication network and said receiving of said voucher data object are performed substantially simultaneously; and wherein
said generating said second specifically encrypted access object for said second terminal unit, and said sending of said generated second specifically encrypted access object destined to said second terminal unit are performed substantially successively.

4. Method according to claim 2, further comprising storing said voucher data object in a memory of said server.

5. Method according to claim 1, wherein said migration server further comprises a database for specifically encrypted access objects, said database comprising storage entries for circulating specifically encrypted access objects and terminal units specifically encrypted access objects have been allocated for, said method further comprising:
deleting an entry of said first specifically encrypted access object of said first terminal unit in said database for specifically encrypted access objects; and
generating a new entry for said second specifically encrypted access object of second terminal unit in said database for specifically encrypted access object.

6. Method according to claim 5, further comprising:
checking if there is an entry of said first specifically encrypted access object of said first terminal unit in said database for specifically encrypted access objects; and
in case of a negative checking result
generating a migration refusal message;
sending said migration refusal message;
terminating the method before generating said new entry and/or before generating a second specifically encrypted access object.

7. Method according to claim 1, further comprising
dispatching, via said communication network, a command to the first terminal unit to delete said first specifically encrypted access object.

8. Method according to claim 7, further comprising
receiving a confirmation from said first terminal unit that said first specifically encrypted access object has been deleted.

9. Method, comprising:
receiving, via a communication network, a voucher data object at a terminal device;
storing said voucher data object in a voucher data object storage of said terminal device; and
sending, via said communication network, said voucher data object from said terminal device.

10. Method according to claim 1, wherein said communication network is a cellular communication network and said terminal device is a mobile cellular terminal of said cellular communication network.

11. Machine-readable medium comprising program code sections to instruct a controller, processor-based device, a computer, a microprocessor based device, a terminal, a network device, a mobile terminal, or a mobile communication-enabled terminal to:
receive, via a communication network, a first specifically encrypted access object of a first terminal unit, and identification data related to said first terminal unit and to a content said first specifically encrypted access object is destined for;
receive, via a communication network, identification data related to a second terminal unit, and a request for issuing a second specifically encrypted access object for said second terminal unit;
check if said request is authorized;
generate, if said request is authorized, a second specifically encrypted access object for said second terminal unit, being destined for said content; and
send, via said communication network, said generated second specifically encrypted access object destined to said second terminal unit.

12-14. (canceled)

15. Server, comprising:
an interface coupled to a communication network for receiving a first specifically encrypted access object of a first terminal unit, and identification data related to said first terminal unit and to a content said first specifically encrypted access object is destined for, and identification data related to a second terminal unit and a request for issuing a second specifically encrypted access object for said second terminal unit;
a checking instance connected to said interface for checking if said received request is authorized;
generating means for generating second specifically encrypted access objects, said generating means being connected to said checking instance, said generating means being configured for generating a second specifically encrypted access object for said second terminal unit being destined for said content;
at least one storage connected to said checking instance; wherein
said checking instance is configured to determine if a received request for a second specifically encoded access object is authorized;
said generating means is configured to generate said second specifically coded access object according to a received identification data related to said second terminal unit, if said request is authorized;
said storage is configured to store specifically encrypted access objects; and
said interface is configured to send said second specifically encrypted access object destined to said second terminal unit via said communication network.

16. Server according to claim 15, further comprising:
means for generating a voucher data object; wherein
said interface to said communication network is further configured for sending and receiving voucher data objects via said communication network; and
said checking instance is configured to check if a received voucher data object is valid.

17. Server according to claim 15, further comprising
a database for specifically encrypted access objects; wherein
said database comprises storage entries for circulating specifically encrypted access objects and terminal units specifically encrypted access objects have been allocated for; and
said database for specifically encrypted access objects is connected to said checking instance and to said generating means.

18. Server according to claim 15, wherein said network server is a server of a cellular communication network, said interface is an interface to said cellular communication network and is configured for receiving at least one terminal device identification of a mobile cellular terminal device.

19. Device, comprising
a communication network interface;
a central processing unit; and
a voucher data object storage;
wherein said central processing unit is connectable to both said communication network interface and said voucher data object storage.

20. Device according to claim 19, wherein said terminal device is a mobile cellular terminal device for a cellular communication network, and said communication network interface is an interface to said cellular communication network.

21. Device, comprising:
means for receiving a first specifically encrypted access object of said first terminal unit via a communication network;
means for receiving identification data related to said first terminal unit and to a content said first specifically encrypted access object is destined for;
means for receiving identification data related to said second terminal unit;
means for receiving a request for issuing a second specifically encrypted access object for said second terminal unit;
means for checking if said received request is authorized;
means for generating a second specifically encrypted access object for said second terminal unit being destined for said content;
means for storing specifically encrypted access objects;
means for determining if a received request for a second specifically encoded access object is authorized;
means for generating said second specifically coded access object according to a received identification data related to said second terminal unit, if said request is authorized;
means for sending said second specifically encrypted access object destined to said second terminal unit via said communication network.

22. A server comprising:
an interface coupled to a communication network for receiving a first specifically encrypted access object of a first terminal unit, and identification data related to said first terminal unit and to a content said first specifically encrypted access object is destined for, and identification data related to a second terminal unit and a request for issuing a second specifically encrypted access object for said second terminal unit;
at least one storage;
a processing module configured to determine whether the received request is authorized and to generate at least one second specifically encrypted access object for said second terminal unit being destined for said content, and further configured to determine whether a received request for a second specifically encoded access object is authorized; and
wherein said at least one storage is configured to store specifically encrypted access objects, and said interface is configured to send said second specifically encrypted access object destined to said second terminal unit via said communication network.
